(19) United States
(12) Patent Application Publication
(10) Pub. No.: US 2007/0288690 A1
(43) Pub. Date: Dec. 13, 2007

(54) HIGH BANDWIDTH, HIGH CAPACITY LOOK-UP TABLE IMPLEMENTATION IN DYNAMIC RANDOM ACCESS MEMORY

(75) Inventors: Shingyu Wang, Cupertino, CA (US); Yuen Wong, San Jose, CA (US)

Correspondence Address: MACPHERSON KWOK CHEN & HEID LLP, 2033 GATEWAY PLACE, SUITE 400, SAN JOSE, CA, 95110, US

(73) Assignee: Foundry Networks, Inc.

(21) Appl. No.: 11/611,067

(22) Filed: Dec. 14, 2006

Related U.S. Application Data
(60) Provisional application No. 60/813,104, filed on Jun. 13, 2006.

(51) Int. Cl. G06F 13/28

(52) U.S. Cl. 711/105; 711/157

(57) ABSTRACT

Fixed-cycle latency accesses to a dynamic random access memory (DRAM) are designed for read and write operations in a packet processor. In one embodiment, the DRAM is partitioned to a number of banks, and the allocation of information to each bank to be stored in the DRAM is matched to the different types of information to be looked up. In one implementation, accesses to the banks can be interleaved, such that the access latencies of the banks can be overlapped through pipelining. Using this arrangement, near 100% bandwidth utilization may be achieved over a burst of read or write accesses.

### CROSS REFERENCE TO RELATED APPLICATIONS

The present application claims priority of U.S. provisional patent application No. 60/813,104, filed Jan. 13, 2006, incorporated herein by reference.

### BACKGROUND OF THE INVENTION

1. Field of the Invention

The present invention relates to high bandwidth network devices. In particular, the present invention relates to implementing high capacity look-up tables in a high bandwidth network device.

2. Description of Related Art

Look-up tables are frequently used in network or packet-processing devices. However, such look-up tables are often bottle-necks in networking applications, such as routing. In many applications, the look-up tables are required to have a large enough capacity to record all necessary data for the application and to handle read and write random-access operations to achieve high bandwidth utilization. In the prior art, Quad Data Rate (QDR) static random access memory (SRAM) have been used to meet the bandwidth requirement. At six transistors per cell, SRAMs are relatively expensive in silicon real estate, and therefore are only available in small capacity (e.g., 72 Mb). A memory structure and organization that provide both a high bandwidth and a high density is therefore desired.

### SUMMARY

A packet processor (e.g., a router or a switch) that receives data packets includes a single input and output data bus, a central processing unit and a dynamic random access memory having multiple banks each receiving data from the data bus and providing results on the data bus with each bank storing a look-up table for resolving a field in the header of each data packet. The accesses to each bank may be of fixed latency. The packet processor may access the banks of the memory in a predetermined sequence during packet processing.

Because of the higher density that may be achieved using DRAM than other memory technologies, the present invention allows larger look-up tables and lower material costs be realized simultaneously.

In one embodiment, a memory controller is provided that includes a scheduler that efficiently schedules memory accesses to the dynamic random access memory, taking advantage of the distribution of data in the memory banks and overlapping the memory accesses to achieve a high bandwidth utilization rate.

The present invention is better understood upon consideration of the detailed description below in conjunction with the accompanying drawings.

### BRIEF DESCRIPTION OF THE DRAWINGS

FIG. 1 shows a packet processor in which source and destination look-up tables are stored in an interleaved manner into four banks 101-104, in accordance with one embodiment of the present invention.

FIG. 2 is a timing diagram showing packet processing using a 4-bank DRAM under a “burst-4” configuration, in accordance with one embodiment of the present invention.

FIG. 3 is a timing diagram showing packet processing using a 4-bank DRAM under a “burst-8” configuration, in accordance with one embodiment of the present invention.

FIG. 4 shows DRAM controller 107 of DRAM system 100 of FIG. 1, including scheduler 401, finite state machine 402, and DDR interface 403, according to one embodiment of the present invention.

### DETAILED DESCRIPTION OF THE PREFERRED EMBODIMENTS

To increase the look-up table capacity, dynamic random access memories (DRAMs) may be used in place of SRAMs. Unlike SRAMs, for which six transistors are required in each memory cell, each DRAM cell uses for storage purpose a capacitor formed by a single transistor. Generally, therefore, DRAMs are faster and achieve a higher data density.

However, a DRAM system has control requirements not present in an SRAM system. For example, because of charge leakage from the capacitor, a DRAM cell is required to be “refreshed” (i.e., read and rewritten) every few milliseconds to maintain the valid stored data. In addition, for each read or write access, the controller generates three or more signals (i.e., pre-charge, bank, row and column enable signals) to the DRAMs, and these signals each have different timing requirements. Also, DRAMs are typically organized such that a single input and output data bus is used. As a result, when switching from a read operation to a write operation, or vice versa, extra turn-around clock cycles are required to avoid a data bus conflict.

The extra complexity makes it very difficult in a DRAM system to achieve a bandwidth utilization rate of greater than 50% in random access-type operations. However, much of the complexity can be managed if the DRAM system is used primarily for look-up table applications. This is because look-up tables are rarely updated during operations. In a look-up table application, write accesses to the look-up tables are primarily limited to initialization, while subsequent accesses are mostly read accesses; turn-around cycles are therefore intrinsically limited to a minimum.

Taking advantage of the characteristics of the look-up table applications, according to one embodiment of the present invention, fixed-cycle latency accesses are designed for read and write operations. In that embodiment, the DRAM system is divided into a number of banks. The information to be accessed is distributed among the banks according to the pattern in which the information is expected to be accessed. If the information access pattern is matched to a conflict-free access sequence to the banks, the latencies of the banks may be overlapped through a pipelining technique and by using burst access modes supported by the DRAM system. With a high degree of overlap, a high bandwidth utilization rate (e.g., up to 100%) can be achieved. To achieve this high bandwidth utilization, techniques such as destination pre-sorting and stored data duplication may need to be applied.

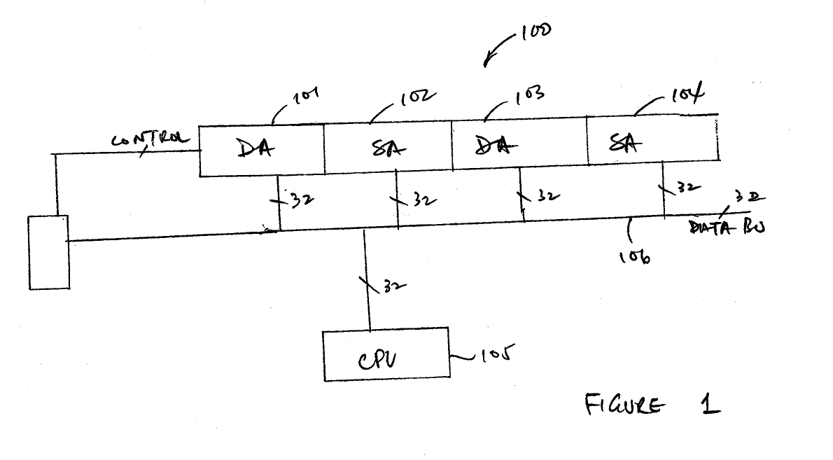

In one embodiment of the present invention, as shown in FIG. 1, DRAM system 100 is physically partitioned into four memory banks (labeled 101-104), under control of memory controller 107. DRAM system 100 receives memory access requests from CPU 105. The use of four memory banks is for illustration only, depending on the application, DRAM system 100 may be 8 banks or any suitable number. In this embodiment, each bank is accessed independently. This memory system may be used for packet processing in a network router application, for example. In such an application, the packet processor could issue from 3 to 6 look-up requests for each packet handled. For example, for layer 2 packet processing, separate look-ups for source addresses (SAs) and destination addresses (DAs) may be required. As another example, in Ipv4 or Ipv6 networks, access control lists (ACLs) and secured password authentication (SPA) look-ups may be issued. In one instance, each request may takes four clock cycles and returns a 256-byte result.

Referring to FIG. 1, DRAM system 100 holds a table for layer 2 look-up used in a packet processing application. During initialization, identical DA tables are loaded into banks 101 and 103 and identical SA tables are loaded into banks 102 and 104. During packet processing, CPU 105 issues look-up requests for DA and SA alternatively. For example, the sequence DA0, SA0, DA1, SA1 . . . Dai, SAi, . . . DAn and SAn is issued, where #i denotes the ith incoming packet. In that sequence, banks 101, 102, 103 and 104 can be accessed in cycle efficiently, reading DA0, DA2, . . . from bank 101; SA0, SA2 . . . from bank 102; DA1, DA3, . . . from bank 103; and SA1, SA3, . . . from bank 104, respectively. In one embodiment, each access takes 16 clock cycles, with the result occupying data bus 106 for 4 cycles. In conjunction with selecting a “burst-8” mode (i.e., an access mode that provides eight output data words in four successive clock cycles), which is supported in many popular synchronous double data rate (DDR) DRAMs, this scheme may achieve a 100% bandwidth utilization.

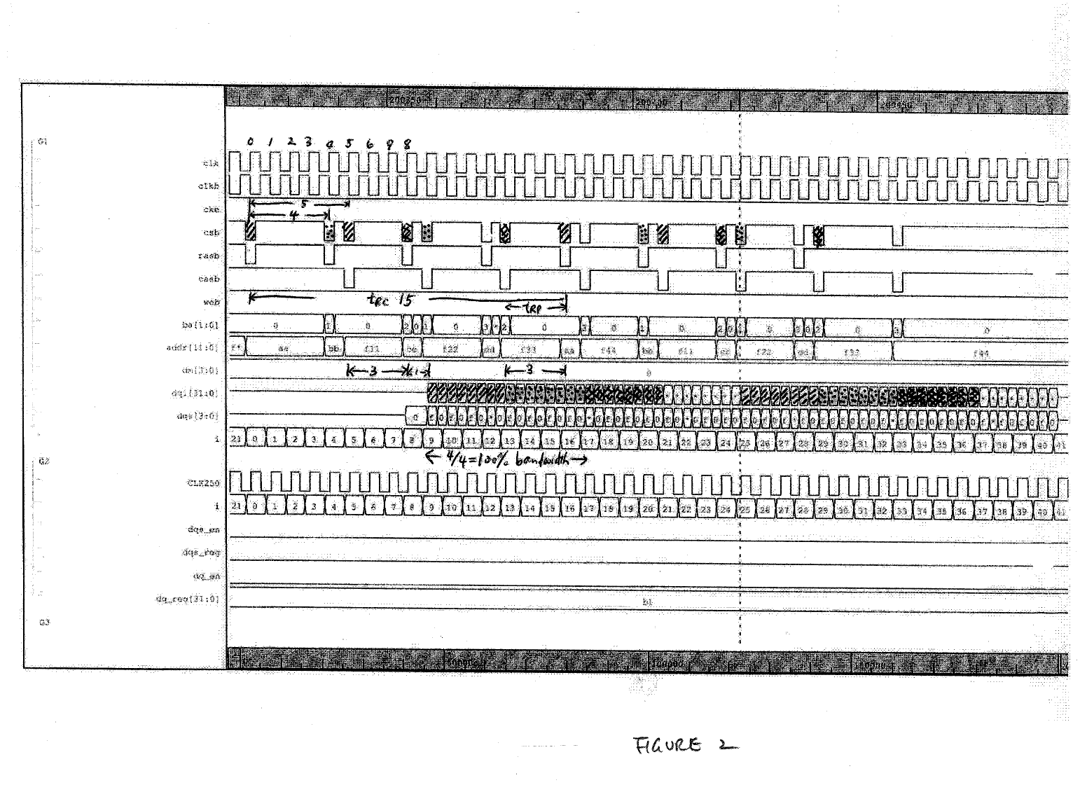

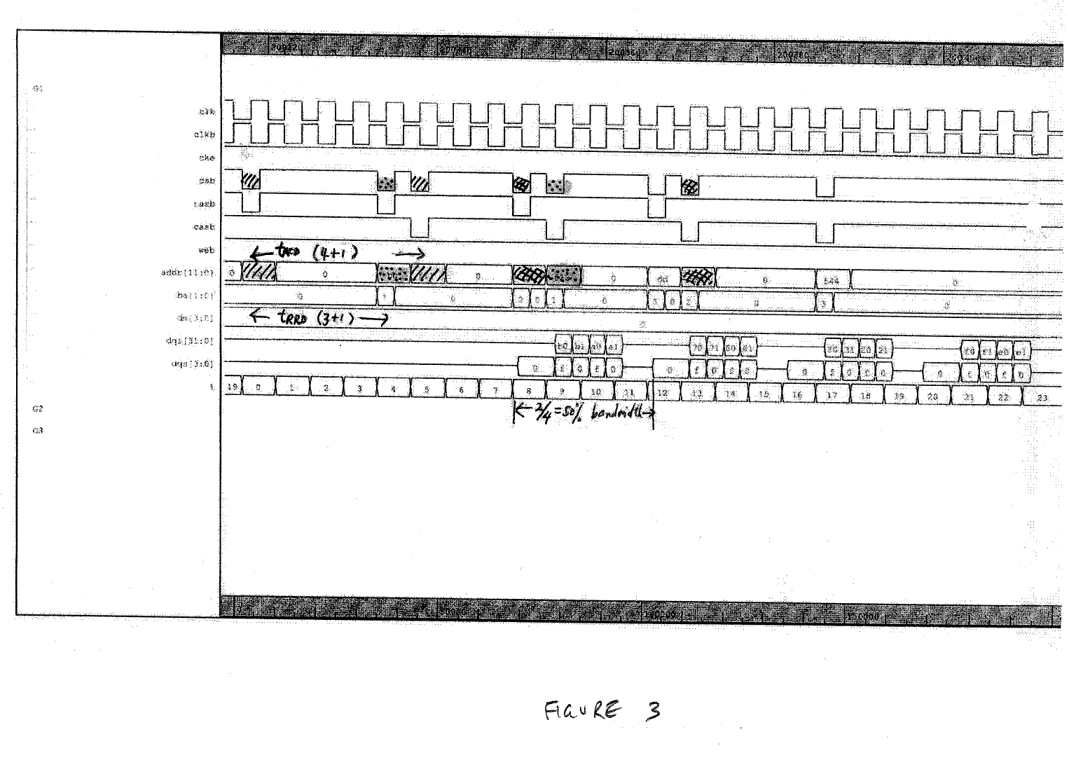

Because a narrower result data path can expect less jitter or alignment problem, by narrowing the data path, the packet processor may operate at a higher frequency. For example, using QDR SRAM returns a 128-bit data result per half-cycle, while look-up requests are issued one per clock cycle. Using double data rate (DDR) DRAMs, a 32-bit result can be obtained per half-cycle, while latency is 4 clock cycles per request. As a 32-hit data path can expect less jitter or alignment problem than a 128-hit data path, the packet processor can operate at a higher clock rate by implementing the memory system using DDR DRAMs, rather than QDR SRAMs. In addition, because of the fewer pin counts required for the data bus—a single data bus for a DRAM implementation, as opposed to input and output data buses in an SRAM implementation—routing congestion on the circuit hoard can be expected. Consequently, a memory system of the present invention can easily handle a 10 Gbits/second packet processor, and can be scaled without degradable for a 40 Gbits/second packet processor. Such a memory system is illustrated below in conjunction with FIGS. 2 and 3.

FIG. 2 is a timing diagram showing packet processing using a 4-bank DRAM under a “burst-4” configuration, in accordance with one embodiment of the present invention. As shown in FIG. 2, at cycle 0, both “chip select” (“CS”) signal csb and “row address strobe” (“RAS”) signal rasb are asserted to activate row address aa (on address bus addr[11:0]) of bank ‘0’, which is specified on bank select bus ba[1:0]. In this embodiment, the minimum time t_{RRD} between assertions of RAS signal rasb is three (3) clock cycles. Thus, at cycle 4, CS signal csb and RAS signal rasb are asserted to activate row address bb of bank ‘1’. In this embodiment, the minimum time t_{RCD} between assertion of RAS signal rasb and a corresponding assertion of “column address strobe” (“CAS”) signal casb is four (4) cycle. Thus, at cycle 5, both CS signal csb and CAS signal casb are asserted to provide column address f11 on address bus addr[11:0]. In this embodiment, a burst-4 mode is used. Consequently, at cycles 9-10, the data words b0, b1, a0 and a1 at four memory locations, beginning at memory location (aa, f11), are provided on data bus dgi[31:0] synchronized to the edges of the clock signal. (At cycle 8, the DRAM system indicates output of read data in the next cycle by driving onto “data strobe” signal dqs[3:0] hexadecimal value ‘0’ of ‘f’). FIG. 2 shows RAS signal rasb and CAS signal casb are each asserted every four clock cycles, so that four data words are provided during two of the four clock cycles. Thus, a bandwidth utilization rate of 50% is achieved.

FIG. 3 is a timing diagram showing packet processing using a 4-bank DRAM under a “burst-8” configuration, in accordance with one embodiment of the present invention. The CS, RAS and CAS signaling shown in FIG. 3 is the same as the corresponding signaling of FIG. 2. However, unlike the DRAM system of FIG. 2, the DRAM system of FIG. 3 is configured for “burst-8” operation. Thus, at cycles 9-12, eight data words at eight memory locations, beginning at memory location (aa, f11), are provided on data bus dgi[31:0] synchronized to the edges of the clock signal. Thus, a bandwidth utilization rate of 50% is achieved.

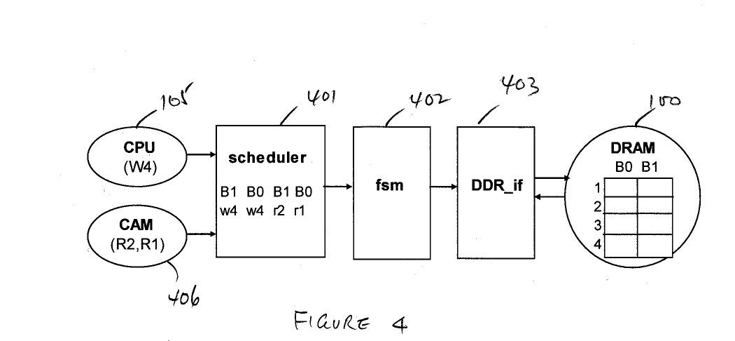

According to one embodiment of the present invention, which is shown in FIG. 4, DRAM controller 107 of DRAM system 100 includes scheduler 401, finite state machine 402, and DDR interface 403. DDR interface 403 may be a conventional DDR DRAM controller that generates the necessary control signals (e.g., RAS, CAS, CS) for operating the DDR DRAM devices in each of the memory array or arrays in memory banks 101-103.

In one packet processing application, DRAM system 100 receives memory access requests from CPU 105 and other devices. In one embodiment, DRAM system 100 receives memory access requests from a content addressable memory (CAM 406). Such a CAM may be used, for example, as a cache memory for packet processing. In many packet processing applications, a table lookup operation is most efficiently performed by a content addressable memory. However, such table look-up operation can also be performed using other schemes, such as using a hashing function to obtain an address for a non-content addressable memory. The content addressable memory is mentioned here merely as an example of a source of a DRAM access requests. Such memory access requests may come from, for example, any search operation or device.

Scheduler 401 shares the bandwidth between CPU 105 and CAM 406, by scheduling and ordering the memory access requests using its knowledge how the various data types are distributed and duplicated in the memory banks. For example, FIG. 4 illustrates DRAM system 100 receiving a write request (W4) from CPU 105 and two read requests (R1 and R2) from CAM 406. (W4 indicates a write access to address location 4; R1 and R2 represent read accesses to address locations 1 and 2, respectively). In this embodiment, the data in bank B0 is duplicated in bank B1. Thus, as CAM 406 is assigned a higher priority to DRAM system 100 than CPU 105, scheduler module 401 schedules read accesses to address location 1 at bank 0 (B0R1) and address location 2 at bank 1 (B1R2) to overlap the memory accesses to achieve a high bandwidth utilization rate. The write accesses then follow these read accesses. Because the data at bank 0 is duplicated in bank 1, write accesses to address location 4 at both banks are scheduled.

After receiving read or write operation requests from scheduler 401, (e.g., stored in order a first-in-first out memory, or FIFO), finite state machine 402 sets control flags for generating RAS or CAS signals. When an read access follows a write access, finite state machine 402 also generates the necessary signals to effectuate a “turn around” at the data bus (i.e., from read access to write access, or vice versa). Finite state machine 402 also generates control signals for refreshing DRAM cells every 4000 cycles or so.

DRAM system 100 may be extended to allow scheduler module 401 to receive memory access requests from more than two functional devices (i.e., in addition to CAM 406 nand CPU 105). Also, in another embodiment, a 4-bank DRAM system maintains two look-up tables. In that embodiment, one look-up table is duplicated in banks 0 and 1, while the other look-up table is duplicated in banks 2 and 3. In another embodiment including a 4-bank DRAM system, one look-up table is duplicated in all four banks.

In some situations, memory access requests are required to be executed in the order they are received. For example, read and write accesses to the same memory location should not be executed out of order. As another example, in one packet processing application implemented in a system with two DRAM modules 0 and 1, if CAM 406 accesses DRAM module 0 for data packets P0 and P1, and accesses both DRAM module 0 and DRAM module 1 for data packet P2, the access to DRAM module 1 for packet P2 may complete much ahead of the corresponding access for packet P2 at DRAM module 0, as DRAM module 0 may not have completed the pending accesses for packets P0 and P1. To maintain coherency, one implementation has scheduler 401 issues non-functional instructions, termed “bogus-read” and “bogus-write” instructions. Finite state machine 402 implements a “bogus-read” instruction as a read operation in which data is not read from the output data bus of the DRAM module. Similarly, the “bogus-write” is implemented by an idling the same number cycles as the latency of a write instruction. (Of course, a “bogus-read” instruction can also be implemented by idling the same number of cycles as the latency of a read instruction.) By issuing “bogus-read” and “bogus-write” instructions, synchronized or coherent operations are achieved in a multiple DRAM module system.

The above detailed description is provided to illustrate specific embodiments of the present invention and is not intended to be limiting. Many variations and modifications within the scope of the present invention are possible. The present invention is set forth in the following claims.

We claim:

1. A packet processor receiving data packets each including a header of a plurality of fields, comprising:
a data bus;
a dynamic random access memory having a plurality of banks each receiving data from the data bus and providing results on the data bus, each bank storing a look-up table for resolving a field of the header of each data packet; and
a central processing unit receiving the data packets and in accordance with the fields of each data packet generating memory accesses to the banks of the dynamic random access memory.

2. A packet processor as in claim 1, wherein the banks of the memory are accessed in a predetermined sequence during packet processing.

3. A packet processor as in claim 2, wherein each access has a fixed latency.

4. A packet processor as in claim 1, wherein the look-up table is duplicated in two of the banks.

5. A packet processor as in claim 1, wherein the dynamic random access memory further comprises a controller which includes a scheduler, and wherein the scheduler selects and schedules the memory bank to access for each memory access received.

6. A packet processor as in claim 5, wherein the controller further comprises a finite state machine for effectuating the scheduler's selection and schedules.

7. A packet processor as in claim 6, wherein the scheduler inserts non-functional memory accesses to preserve an order of execution of the memory accesses.

8. A method for processing a data packet, comprising:
providing a dynamic random access memory having a plurality of banks each receiving data from a data bus and providing results on the data bus;
storing in each bank a look-up table, each look-up table being provided to resolve a field of a header of the data packet; and
receiving the data packet and, in accordance with the fields of the data packet, generating memory accesses to banks of the the dynamic random access memory.

9. A method as in claim 8, wherein the memory accesses are generated in a manner such that the banks of the memory are accessed in a predetermined sequence.

10. A method as in claim 9, wherein each access has a fixed latency.

11. A method as in claim 8, further comprising duplicating one of the look-up tables in two of the banks.

12. A method as in claim 8, further comprising providing in the dynamic random access memory a controller which includes a scheduler, and wherein the scheduler selects and schedules the memory bank to access for each memory access received.

13. A method as in claim 12, further comprising providing in the controller a finite state machine for effectuating the scheduler's selection and schedules.

14. A method as in claim 13, wherein the scheduler inserts non-functional memory accesses to preserve an order of execution of the memory accesses.
